(19) United States
(12) Patent Application Publication
(10) Pub. No.: US 2015/0071364 A1
(43) Pub. Date: Mar. 12, 2015

(54) Power Line Communication using Padding to Overcome Interleaver Failings

(71) Applicant: Texas Instruments Incorporated, Dallas, TX (US)

(72) Inventors: Anuj Batra, Dallas, TX (US); Tarkesh Pande, Richardson, TX (US); IL Han Kim, Allen, TX (US); Robert Weibo Liang, Frisco, TX (US); Mehul Madhav Soman, Dallas, TX (US)

(21) Appl. No.: 14/458,662

(22) Filed: Aug. 13, 2014

Related U.S. Application Data
(60) Provisional application No. 61/877,100, filed on Sep. 12, 2013.

(51) Int. Cl. H04B 3/54; H04L 12/931

(52) U.S. Cl. CPC H04B 3/542; H04L 49/20
USPC 375/257

(57) ABSTRACT

In a method for transmitting frames of data across a physical media that has a selective frequency response, a packet of data bytes is received by a media access (MAC) layer of a communication protocol from a local application for transmission to a remote receiver. The packet of data bytes is padded to from a padded packet of data bytes having a predetermined frame length, wherein the predetermined frame length is a frame length that is predetermined to provide correct transmission of a frame of data across the physical media that has a selective frequency response. The padded packet of data bytes is encoded by a physical (PHY) layer of the communication protocol to form multiple tone symbols. The multi-tone symbols are then transmitted on the physical media to the remote receiver.

### CLAIM OF PRIORITY UNDER 35 U.S.C. 119(e)

The present application claims priority to and incorporates by reference U.S. Provisional Application No. 61/877,100, (attorney docket TI-74317PS) filed Sep. 12, 2013, entitled “Padding to Overcome Interleaver Failings.”

### FIELD OF THE INVENTION

This invention generally relates to reliable communication between devices, and in particular to communication over power lines.

### BACKGROUND OF THE INVENTION

Power Line Communication (PLC) is one of the technologies used for automatic meter reading, for example. Both one-way and two-way systems have been successfully used for decades. Interest in this application has grown substantially in recent history because utility companies have an interest in obtaining fresh data from all metered points in order to better control and operate the utility grid. PLC is one of the technologies being used in Advanced Metering Infrastructure (AMI) systems.

A PLC carrier repeating station is a facility at which a PLC signal on a power line is refreshed. The signal is filtered out from the power line, demodulated and modulated, and then re-injected onto the power line again. Since PLC signals can carry long distances (several 100 kilometers), such facilities typically exist on very long power lines using PLC equipment.

In a one-way system, readings “bubble up” from end devices (such as meters), through the communication infrastructure, to a “master station” which publishes the readings. A one-way system might be lower-cost than a two-way system, but also is difficult to reconfigure should the operating environment change.

In a two-way system, both outbound and inbound traffic is supported. Commands can be broadcast from a master station (outbound) to end devices, such as meters, that may be used for control and reconfiguration of the network, to obtain readings, to convey messages, etc. The device at the end of the network may then respond (inbound) with a message that carries the desired value. Outbound messages injected at a utility substation will propagate to all points downstream. This type of broadcast allows the communication system to simultaneously reach many thousands of devices. Control functions may include monitoring health of the system and commanding power shedding to nodes that have been previously identified as candidates for load shed. PLC also may be a component of a Smart Grid.

The power line channel is very hostile. Channel characteristics and parameters vary with frequency, location, time and the type of equipment connected to it. The lower frequency regions from 10 kHz to 200 kHz are especially susceptible to interference. Furthermore, the power line is a very frequency selective channel. Besides background noise, it is subject to impulsive noise often occurring at 50/60 Hz, and narrowband interference and group delays up to several hundred microseconds.

OFDM is a modulation technique that can efficiently utilize this limited low frequency bandwidth, and thereby allows the use of advanced channel coding techniques. This combination facilitates a very robust communication over a power line channel.

On Sep. 30, 2010, the IEEE's 1901 Broadband Powerline Standard was approved and HomePlug AV, as baseline technology for the FFT-OFDM PHY within the standard, is now ratified and validated as an international standard. The HomePlug Powerline Alliance is a certifying body for IEEE 1901 products. The three major specifications published by HomePlug (HomePlug AV, HomePlug Green PHY and HomePlug AV2) are interoperable and compliant.

Another set of open standards has been developed for power line communication (PLC) at the request of Electricité Réseau Distribution France (ERDF), a wholly owned subsidiary of the EDF (Electricité de France) Group. The set of standards include “PLC G3 Physical Layer Specification,” and “PLC G3 MAC Layer Specification.” These standards are intended to facilitate the implementation of an automatic meter-management (AMM) infrastructure in France; however, PLC using these standards or similar technology may be used by power utilities worldwide.

The G3 standards promote Interoperability and coexists with IEC 61334, IEEE® P1901, and ITU G.hn systems. 10 kHz to 490 kHz operation complies with FCC, CENELEC, and ARIB. CENELEC is the European Committee for Electrotechnical Standardization and is responsible for standardization in the electro technical engineering field. ARIB is a Japanese standards organization.

### BRIEF DESCRIPTION OF THE DRAWINGS

Particular embodiments in accordance with the invention will now be described, by way of example only, and with reference to the accompanying drawings:

FIG. 1 is a conceptual diagram of a PLC system that uses packet padding;

FIG. 2 is a block diagram of an example PLC device or modem for use in the PLC system of FIG. 1;

FIG. 3 is a block diagram of an example PLC gateway for use in the PLC system of FIG. 1;

FIG. 4 is a block diagram of an example PLC data concentrator for use in the PLC system of FIG. 1;

FIG. 5 is a plot illustrating power spectral density for an example PLC channel

FIG. 6 is an architectural diagram of a power line communication system, illustrating the PHY and MAC layers;

FIG. 7 is a flow chart illustrating a method for padding a frame of data to ensure successful transmission on frequency selective PLC channels; and

FIG. 8 illustrates a block diagram of an exemplary low cost, low power G3 and 1901.2 compatible device.

Other features of the present embodiments will be apparent from the accompanying drawings and from the detailed description that follows.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the

### DESCRIPTION

Power line communication (PLC) devices operate in the presence of harsh channel and noise environments, such as frequency-selective channels, narrowband interference, and impulsive noise. Traditionally, repetition coding is used to improve the robustness of PLC devices in these harsh environments. However, repetition coding comes at the expense of decreased data rates. As an example, IEEE 1901.2, ITU-G.9903 (G3-PLC) and ITU G.9904 (PRIME) all have a mode, called ROBO or Robust mode, where the information bit is repeated 4 times. This repetition coding helps to ensure that a PLC device can connect with other PLC devices even in the presence of the harsh environments.

G3-PLC device can operate in several bands: CENELEC A (35.9375-90.625 kHz), CENELEC B (98.4375-121.875 kHz), ARIB (154.6875-403.125 kHz) and FCC (154.6875-487.5 kHz) bands. In each of these bands, the critical network messages, such as network formation, routing, management, etc., are sent using either ROBO (repetition by 4) or Super ROBO (repetition by 6) mode.

Within a band of interest, such as CENELEC A: 35.9375-90.625 kHz, for example, the higher 24 tones (54.6875-90.625 kHz) may experience deep fading, which essentially ensures that no information can be received on them. Thus, typically only the lower 12 tones (35.9375-53.125 kHz) may be used to communicate data. This is equivalent to puncturing the higher 24 tones for each OFDM symbol. Note that the information bits, including the repeated bits, are actually transmitted on all 36 tones in ROBO mode. After the channel, the received data stream may look like 12 “received bits” followed by 24 “erased bits” (low signal values, essentially zeros) for each OFDM symbol.

At the receiver, the received data stream is equalized, sliced (calculate soft information), de-interleaved, de-spread (integrating the soft information for the repeated bits), as specified by the G3-PLC or IEEE 190 standard. After these operations, the resulting soft information is sent to a Viterbi decoder. More details about the G3-PLC interleaver/de-interleaver and spreading can be found in the ITU G.9903 February 2014 standard (and future versions), which is incorporated by reference herein.

For certain frame lengths (or equivalently, payload bytes), it turns out that the interleaver/de-interleaver specified by the above mentioned standards for use in PLC communication is poorly designed. For these cases, the output of the de-interleaver may contain long stretches of erasures or very unreliable soft information, which is then de-spread and sent to the Viterbi decoder. The long stretches of erasures or unreliable soft information makes it difficult for the Viterbi decoder to recover/determine the transmitted information sequence. In fact, if the length of consecutive erasures is (nearly) equal or longer than the d_{free} of the code (for the K=7, R=½ code used by G3-PLC, the d_{free}=10), then the Viterbi decoder may not be able to select the correct path. In fact, it will very likely choose the wrong path. This happens even if the SNR (signal to noise ratio) is very high. Thus, the problem is due to the frequency-selective nature of the channel and has less to do with the noise power. Embodiments of the invention may use MAC level frame padding to assure that optimum length frames are transmitted in order to improve the operation of the Viterbi decoder in PLC communication, as will be described in more detail below.

Power line communication using G3 standards reduces infrastructure costs by allowing transmission on medium voltage lines, for example, 12kV, for distances of 6 km or more and across transformers with fewer repeaters. Robust operation over noisy channels is provided by an orthogonal frequency division multiplexing (OFDM)-based PHY (physical) layer. The G3 Mac specification is based on the IEEE 802.15.4-2006 “Wireless Medium Access Control (MAC) and Physical Layer (PHY) Specifications for Low-Rate Wireless Personal Area Networks (WPANs)” which is suitable for lower data rates. Two layers of forward error correction and cyber security features are provided. A 6LoWPAN adaptation layer supports IPv6 packets. An AES-128 cryptographic engine may be included in G3 PLC nodes. Adaptive tone mapping maximizes bandwidth utilization and channel estimation optimizes modulation between neighboring nodes. A mesh routing protocol selects best path between remote nodes. At the MAC layer, a data or command frame may include up to 400 bytes of data. At the PHY layer, a frame may be segmented and transmitted in smaller chunks of data.

IEEE standard 1901.2 specifies communications for low frequency (less than 500 kHz) narrowband power line devices via alternating current and direct current electric power lines. This standard supports indoor and outdoor communications in the following environments: a.) low voltage lines (less than 1000 v), such as the line between a utility transformer and meter; b) through transformer low-voltage to medium-voltage (1000 V up to 72 kV); and c) through transformer medium-voltage to low-voltage power lines in both urban and in long distance (multi-kilometer) rural communications. The standard uses transmission frequencies less than 500 kHz. Data rates will be scalable to 500 kbps depending on the application requirements. This standard addresses grid to utility meter, electric vehicle to charging station, and within home area networking communications scenarios. Lighting and solar panel power line communications are also potential uses of this communications standard. This standard focuses on the balanced and efficient use of the power line communications channel by all classes of low frequency narrow band (LF NB) devices, defining detailed mechanisms for coexistence between different LF NB standards developing organizations (SDO) technologies, assuring that desired bandwidth may be delivered. This standard assures coexistence with broadband power line (BPL) devices by minimizing out-of-band emissions in frequencies greater than 500 kHz. The standard addresses the necessary security requirements that assure communication privacy and allow use for security sensitive services. This standard defines the physical layer (PHY) and the medium access (MAC) sublayer of the data link layer, as defined by the International Organization for Standardization (ISO) Open Systems Interconnection (OSI) Basic Reference Model.

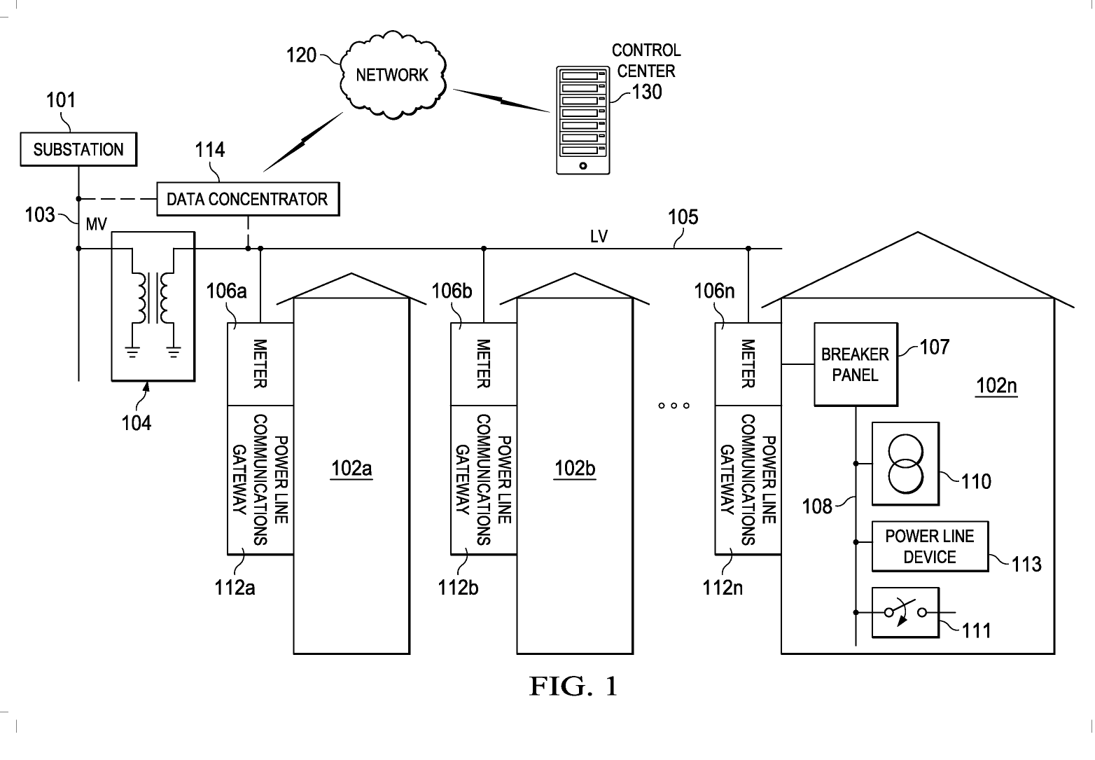

FIG. 1 is a conceptual diagram of a PLC system in which an electric power distribution system is depicted. Medium voltage (MV) power lines 103 from substation 101 typically carry voltage in the tens of kilovolts range. Transformer 104 steps the MV power down to low voltage (LV) power on LV lines 105, carrying voltage in the range of 100-240 VAC. Transformer 104 is typically designed to operate at very low frequencies in the range of 50-60 Hz. Transformer 104 does not typically allow high frequencies, such as signals greater than 100 KHz, to pass between LV lines 105 and MV lines 103. LV lines 105 feed power to customers via meters 106a-n, which are typically mounted on the outside of residences 102a-n. Although referred to as “residences,” premises 102a-n may include any type of building, facility, or location where electric power is received and/or consumed. A breaker panel, such as panel 107, provides an interface between meter 106n and electrical wires 108 within residence 102n. Electrical wires 108 deliver power to outlets 110, switches 111, and other electric devices within residence 102n.

The power line topology illustrated in FIG. 1 may be used to deliver high-speed communications to residences 102a-n. In some implementations, power line communications modems or gateways 112a-n may be coupled to LV power lines 105 at meter 106a-n. PLC modems/gateways 112a-n may be used to transmit and receive data signals over MV/LV lines 103/105. Such data signals may be used to support metering and power delivery applications (e.g., smart grid applications), communication systems, high speed Internet, telephony, video conferencing, and video delivery, to name a few. By transporting telecommunications and/or data signals over a power transmission network, there is no need to install new cabling to each subscriber 102a-n. Thus, by using existing electricity distribution systems to carry data signals, significant cost savings are possible.

An illustrative method for transmitting data over power lines may use, for example, a carrier signal having a frequency different from that of the power signal. The carrier signal may be modulated by the data, for example, using an orthogonal frequency division multiplexing (OFDM) scheme or the like. The examples described below are based on IEEE 1901.2 or G3-PLC, however, other embodiments may use other OFDM based protocols now known or later developed.

PLC modems or gateways 112a-n at residences 102a-n use the MV/LV power grid to carry data signals to and from PLC data concentrator 114 without requiring additional wiring. Concentrator 114 may be coupled to either MV line 103 or LV line 105. Modems or gateways 112a-n may support applications such as high-speed broadband Internet links, narrowband control applications, low bandwidth data collection applications, or the like. In a home environment, for example, modems or gateways 112a-n may further enable home and building automation in heat and air conditioning, lighting, and security. Also, PLC modems or gateways 112a-n may enable AC or DC charging of electric vehicles and other appliances. An example of an AC or DC charger is illustrated as PLC device 113. Outside the premises, power line communication networks may provide street lighting control and remote power meter data collection.

One or more data concentrators 114 may be coupled to control center 130 (e.g., a utility company) via network 120. Network 120 may include, for example, an IP-based network, the Internet, a cellular network, a WiFi network, a WiMax network, or the like. As such, control center 130 may be configured to collect power consumption and other types of relevant information from gateway(s) 112 and/or device(s) 113 through concentrator(s) 114. Additionally or alternatively, control center 130 may be configured to implement smart grid policies and other regulatory or commercial rules by communicating such rules to each gateway(s) 112 and/or device(s) 113 through concentrator(s) 114.

In some embodiments, each concentrator 114 may be seen as a base node for a PLC domain, each such domain comprising downstream PLC devices that communicate with control center 130 through a respective concentrator 114. For example, in FIG. 1, device 106a-n, 112a-n, and 113 may all be considered part of the PLC domain that has data concentrator 114 as its base node; although in other scenarios other devices may be used as the base node of a PLC domain. In a typical situation, multiple nodes may be deployed in a given PLC network, and at least a subset of those nodes may be tied to a common clock through a backbone (e.g., Ethernet, digital subscriber loop (DSL), etc.). Further, each PLC domain may be coupled to MV line 103 through its own distinct transformer similar to transformer 104.

Still referring to FIG. 1, meter 106, gateways 112, PLC device 113, and data concentrator 114 may each be coupled to or otherwise include a PLC modem or the like. The PLC modem may include transmitter and/or receiver circuitry to facilitate the device's connection to power lines 103, 105, and/or 108.

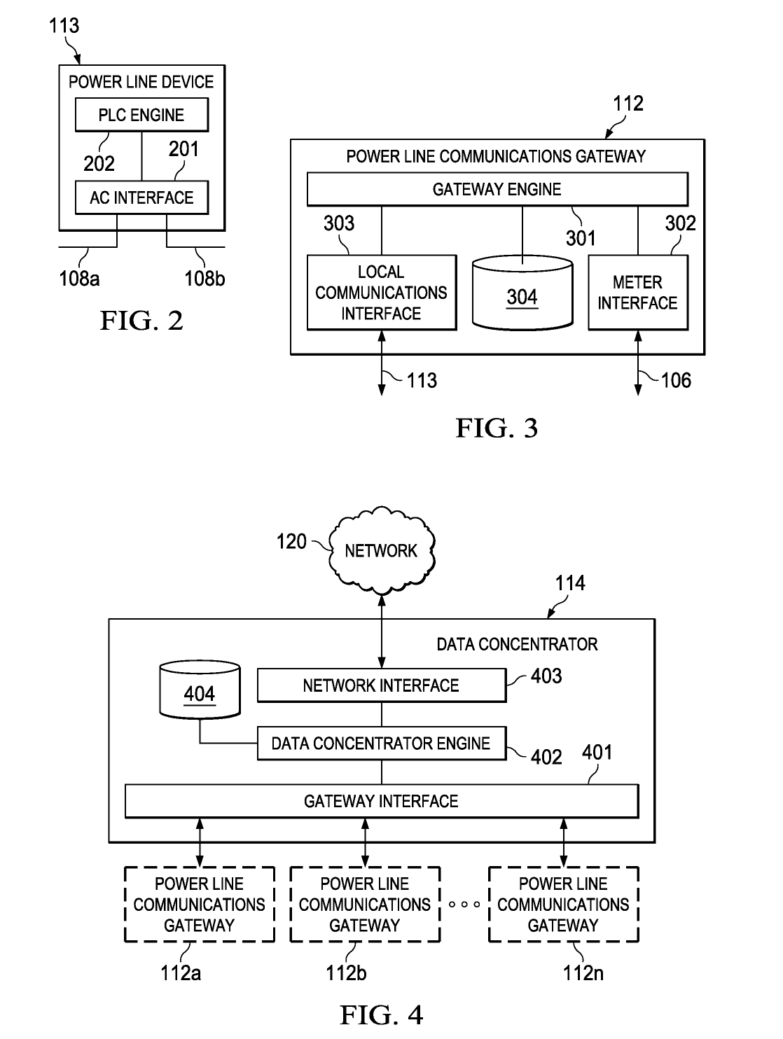

FIG. 2 is a block diagram of PLC device or modem 113 that may include an embodiment of the MAC level packet length padding protocol described herein. As illustrated, AC interface 201 may be coupled to electrical wires 108a and 108b inside of premises 112n in a manner that allows PLC device 113 to switch the connection between wires 108a and 108b off using a switching circuit or the like. In other embodiments, however, AC interface 201 may be connected to a single wire 108 (i.e., without breaking wire 108 into wires 108a and 108b) and without providing such switching capabilities. In operation, AC interface 201 may allow PLC engine 202 to receive and transmit PLC signals over wires 108a-b. As noted above, in some cases, PLC device 113 may be a PLC modem. Additionally or alternatively, PLC device 113 may be a part of a smart grid device (e.g., an AC or DC charger, a meter, etc.), an appliance, or a control module for other electrical elements located inside or outside of premises 112n (e.g., street lighting, etc.).

PLC engine 202 may be configured to transmit and/or receive PLC signals over wires 108a and/or 108b via AC interface 201 using a particular channel or frequency band. In some embodiments, PLC engine 202 may be configured to transmit OFDM signals, although other types of modulation schemes may be used. As such, PLC engine 202 may include or otherwise be configured to communicate with metrology or monitoring circuits (not shown) that are in turn configured to measure power consumption characteristics of certain devices or appliances via wires 108, 108a, and/or 108b. PLC engine 202 may receive such power consumption information, encode it as one or more PLC signals, and transmit it over wires 108, 108a, and/or 108b to higher-level PLC devices (e.g., PLC gateways 112n, data concentrators 114, etc.) for further processing. Conversely, PLC engine 202 may receive instructions and/or other information from such higher-level PLC devices encoded in PLC signals, for example, to allow PLC engine 202 to select a particular frequency band in which to operate. PLC engine 202 may be implemented using a digital signal processor (DSP), or another type of microprocessor, that is executing control software instructions stored in memory that is coupled to the microprocessor, for example, to perform various applications for power line device 113.

FIG. 3 is a block diagram of PLC gateway 112 that may include an embodiment of the MAC level packet length padding protocol described herein. As illustrated in this example, gateway engine 301 is coupled to meter interface 302, local communication interface 303, and frequency band usage database 304. Meter interface 302 is coupled to meter 106, and local communication interface 304 is coupled to one or more of a variety of PLC devices such as, for example, PLC device 113. Local communication interface 304 may provide a variety of communication protocols such as, for example, ZIGBEE, BLUETOOTH, WI-FI, WI-MAX, ETHERNET, etc., which may enable gateway 112 to communicate with a wide variety of different devices and appliances. In operation, gateway engine 301 may be configured to collect communications from PLC device 113 and/or other devices, as well as meter 106, and serve as an interface between these various devices and PLC data concentrator 114. Gateway engine 301 may also be configured to allocate frequency bands to specific devices and/or to provide information to such devices that enable them to self-assign their own operating frequencies.

In some embodiments, PLC gateway 112 may be disposed within or near premises 102n and serve as a gateway to all PLC communications to and/or from premises 102n. In other embodiments, however, PLC gateway 112 may be absent and PLC devices 113 (as well as meter 106n and/or other appliances) may communicate directly with PLC data concentrator 114. When PLC gateway 112 is present, it may include database 304 with records of frequency bands currently used, for example, by various PLC devices 113 within premises 102n. An example of such a record may include, for instance, device identification information (e.g., serial number, device ID, etc.), application profile, device class, and/or currently allocated frequency band. As such, gateway engine 301 may use database 304 in assigning, allocating, or otherwise managing frequency bands assigned to its various PLC devices. PLC gateway engine 301 may be implemented using a digital signal processor (DSP), or another type of microprocessor, that is executing control software instructions stored in memory that is coupled to the microprocessor, for example, to perform various applications for gateway device 112.

FIG. 4 is a block diagram of a PLC data concentrator that may include an embodiment of the MAC level packet length padding protocol described herein. Gateway interface 401 is coupled to data concentrator engine 402 and may be configured to communicate with one or more PLC gateways 112a-n. Network interface 403 is also coupled to data concentrator engine 402 and may be configured to communicate with network 120. In operation, data concentrator engine 402 may be used to collect information and data from multiple gateways 112a-n before forwarding the data to control center 130. In cases where PLC gateways 112a-n are absent, gateway interface 401 may be replaced with a meter and/or device interface (now shown) configured to communicate directly with meters 116a-n, PLC devices 113, and/or other appliances. Further, if PLC gateways 112a-n are absent, frequency usage database 404 may be configured to store records similar to those described above with respect to database 304.

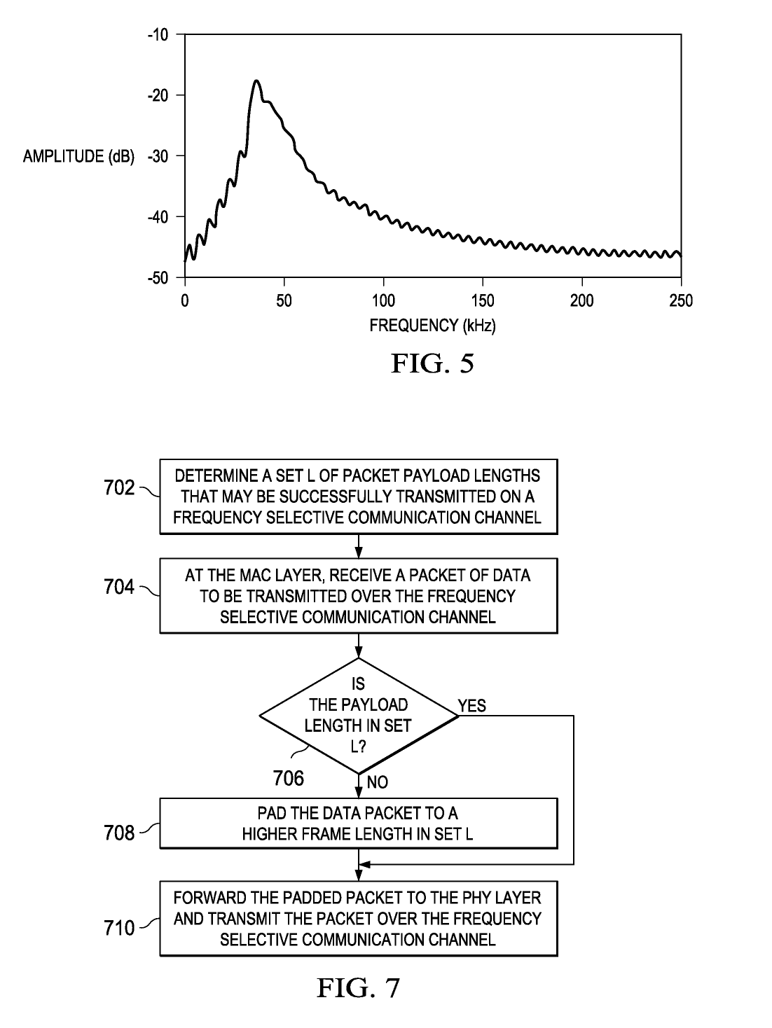

FIG. 5 is a plot illustrating power spectral density for an example PLC channel and is representative of the type of frequency-selective channel that appears on a power line. In the CENELEC A band, the information bits (including the repeated bits) are transmitted using a differential BPSK (DBPSK) modulation scheme on an OFDM system having 36 tones (tone spacing=1.5625 kHz). The repetition coding helps to ensure that packets can be transmitted reliably even on frequency-selective channels, such as the PLC channel illustrated in FIG. 5.

As mentioned above, within the band of interest, such as CENELEC A: 35.9375-90.625 kHz, the higher 24 tones (54.6875-90.625 kHz) experience deep fading, which essentially ensures that no information can be received on them, i.e., only the lower 12 tones (35.9375-53.125 kHz) may be used to communicate data. This is equivalent to puncturing the higher 24 tones for each OFDM symbol. Note that the information bits, including the repeated bits, are actually transmitted on all 36 tones in ROBO mode. After the channel, the received data stream will look like 12 “received bits” followed by 24 “erased bits” (low signal values, essentially zeros) for each OFDM symbol. At the receiver, the received data stream is equalized, sliced (calculate soft information), de-interleaved, de-spread (integrating the soft information for the repeated bits). After these operations, the resulting soft information is sent to the Viterbi decoder.

As mentioned above, for certain frame lengths, it turns out that the interleaver/de-interleaver is poorly designed. For these cases, the output of the de-interleaver may contain long stretches of erasures or very unreliable soft information, which is then de-spread and sent to the Viterbi decoder. The long stretches of erasures or unreliable soft information makes it difficult for the Viterbi decoder to recover/determine the transmitted information sequence. In fact, if the length of consecutive erasures is (nearly) equal or longer than the d_{free} of the code (for the K=7, R=½ code used by G3-PLC, the d_{free}=10), then Viterbi decoder may not be able to select the correct path. In fact, it will very likely choose the wrong path. This happens even if the SNR (signal to noise ratio) is very high. Thus, the problem is due to the frequency-selective nature of the channel and has less to do with the noise power.

This problem results in the G3-PLC modem failing for certain frame lengths over frequency-selective channels. Even though, this problem has been discussed in the context of the CENELEC A band, it turns that this problem also exists for all bands (CENELEC NB, ARIB, and FCC) with the G3-PLC standard. In addition, this problem also exists for all bands (CENELEC NB, ARIB, and FCC) with the IEEE 1901.2 standard. The details of IEEE 1901.2 interleaver/de-interleaver and spreading can be found in the IEEE 1901.2 standard, which is incorporated by reference herein.

### Padding a Frame of Data

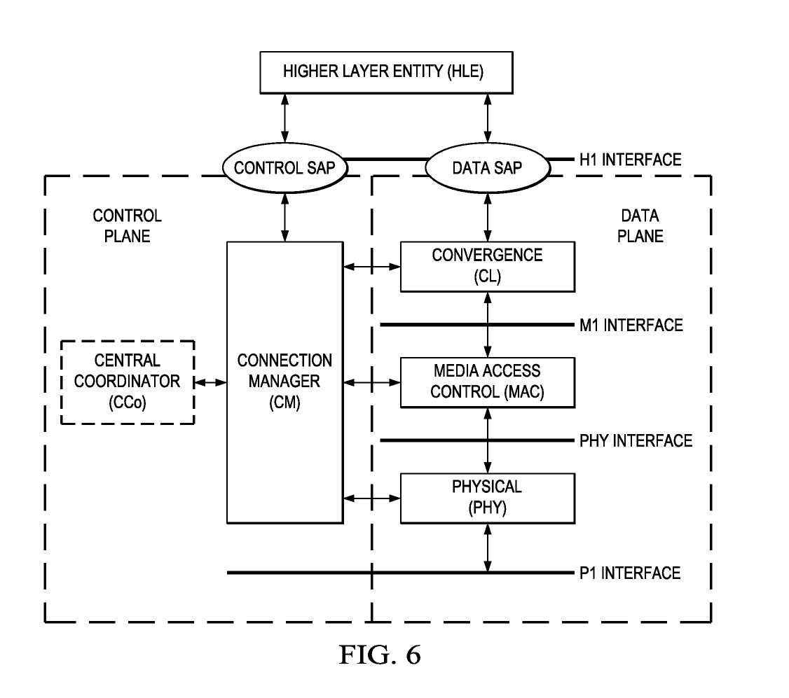

Fortunately, this problem does not occur for all frame lengths. For example, in the CENELEC band the maximum length packet (133 bytes) may be transmitted successfully using ROBO mode across a frequency-selective channel, such as the one described by the channel in FIG. 6. Therefore, a simple and counterintuitive solution is to pad the payload with zero bytes such that the frame length is always the maximum length packer of 133 bytes. This may be easily done at the MAC layer after receiving data from the data service access point and creating the ROBO packets.

Note that the padding does not have to be zero bytes, but could be any set of bytes. As an example, if the application layer passes down a payload of 90 bytes, then the MAC layer may pad the payload to 133 bytes and transmit the result frame using the PLC physical layer (PHY). The reason this solution is counterintuitive is because typically longer packets have a greater chance of failure; however, in this case the longer packets are in fact the more reliable packets because of the limitations imposed by a poorly designed interleaver/de-interleaver that is specified by the G3-PLC standard and also by the IEEE 1901.2 standard.

From a capacity point-of-view, it may not make sense to always pad up to the maximum frame length. For example, when the majority of the packets have a small frame length, the padding may result in a lot of overhead that increases transmission times on the power line, thereby, reducing the overall capacity of the channel/network. While in some cases small packets may be combined to create larger packets, Table 1 provides an example of several types of packets that are defined by the IEEE 1901.2 standard to have a specific length. These examples convey information regarding network joining. In these cases, there is no data from a next packet that can be combined to form a larger packet.

TABLE 1
Examples of defined packets with a short packet length

| | Packet Size |
|---|---|
| Packet Type | (output bytes/symbols) |
| RREQ Packet size | 19 bytes/36 symbols |
| Discover SN->DC Beacon Request | 18 bytes/36 symbols |
| Discover DC->SN Beacon Request | 18 bytes/36 symbols |
| Joining No Security SN->DC Request | 40 bytes/76 symbols |
| Joining No Accepted DC->SN | 36 bytes/54 symbols |

An alternative solution is to determine a set of frame lengths L={L₁, L₂, . . . , L_{N}} that work even over the most severe frequency-selective channels and then pad the payload to the next highest frame length from that set L. Note that if the payload length is in the set L, then the frame can be transmitted as is because it is known that the frame will be transmitted successfully, i.e., padding is not required. For example, if the set L={20, 50, 80, 133} bytes and the payload is 44 bytes, then the payload may be padded so that the frame length would be equal to 50 bytes, a frame length that is known to work on frequency-selective channels. Using this approach, the amount of padding added to each frame may be minimized, thereby preserving the channel/network capacity. Some examples of alternative sets are L={33, 100, 141} bytes. Another example is L={47, 67, 94, 135} bytes.

A set L of payload lengths may be determined in several different manners. One way is to simply transmit a set of packets that have different lengths from a transmission node to receiver node across the frequency selective PLC network and then examine the received packets. For example, a set of packets ranging in length from 10 bytes to the maximum 133 bytes may be transmitted. The test may be repeated multiple times with different data loads to determine any data sensitivities. Those packets that are correctly received may indicate a packet length that may be successfully transmitted on the frequency selective channel. A set L may then be selected from all of the packet lengths that were correctly received.

Another way to determine a set L of payload packet lengths is to simulate operation of a receiver node using simulated OFDM packets in which various higher tones of each OFDM symbol are punctured to simulate the operation of the target frequency selective PLC channel. A simulator that mimics the operation of the equalization, slicing, de-interleaving, de-spreading, and Viterbi decoding may be used. The general operation of simulators is well known and need not be described in more detail herein. For example, reception of a set of packets ranging in length from 10 bytes to the maximum 133 bytes may be simulated. The simulation may be repeated multiple times with different data loads to determine any data sensitivities. Those simulated packets that are correctly received may indicate a packet length that may be successfully transmitted on the frequency selective channel. A set L may then be selected from all of the packet lengths that were correctly received.

The frame lengths contained in the set L may depend upon the frequency band, i.e., a set of frame lengths that work for the CENELEC A band maybe different than a set of frame lengths that work for the ARIB band, for example.

To maximize the channel/network capacity, set L should be as large as possible, which implies that the padding added to a frame will be minimized. Of course, this comes at the expense of complexity. The set L needs to be stored in memory at each modem device. It is possible to trade-off the channel/network capacity vs. complexity by reducing the size of set L.

FIG. 6 is an architectural diagram of a power line communication system, illustrating the PHY (physical) and MAC (media access control) layers used for data packet management as defined by the G3-PLC and IEEE 1901 standards. The Higher Layer Entities (HLEs) above the H1 (Host) Interface may be bridges, applications or servers that provide off-chip services to clients below the H1 Interface. The Data Service Access Point (SAP) accepts Ethernet format packets, so all IP based protocols are easily handled. The PLC communicating standards define two planes as shown in FIG. 6. The data plane provides the traditional layered approach with the M1 interface between the Convergence Layer (CL) and the MAC, and the PHY interface between the MAC and the PHY. In the control plane, the MAC is a monolith without conventional layering. In FIG. 6 it is labeled as the Connection Manager (CM) since that is its primary function. The approach adopted for the control plane was chosen to provide more efficient processing and to provide implementers greater flexibility for innovation. Although part of the control plane may be in all stations, the Central Coordinator (CCo) entity may be active in only one station in a single PLC network.

In order to better understand embodiments of the invention, an overview of IEEE 1901.2 will now be described. Additional details may be found in various IEEE documents. A more detailed overview is provided in “An Overview, History, and Formation of IEEE 1901.2 for Narrowband OFDM PLC”, Jul. 2, 2013, which is incorporated by reference herein.

Details on PHY building blocks have been presented in various IEEE publications. The ultimate result is now a universal PHY structure for NB PLC. The fundamental PHY elements in the transceiver start with the scrambler. The scrambler's function is to randomize the incoming data. Both G3-PLC and PRIME utilize the same generator polynomial, as illustrated in equation 1.

s(x)=x⁷+x⁴+1 Eq 1

Two levels of error correction follow, starting with a Reed-Solomon (RS) encoder where typically data from the scrambler is encoded by shortened systematic Reed-Solomon (RS) codes using Galois Field (GF). The second level of error correction, employed by both G3-PLC and PRIME, uses a ½ rate convolutional encoder with constraint rate K=7. The convolutional encoder is followed by a two-dimensional (time and frequency) interleaver. Together these blocks significantly improve robustness and overall system performance in the presence of noise.

Following the FEC (forward error correction) block is the OFDM modulator. The modulation technique of PRIME and G3-PLC was selected to be used in IEEE 1901.2. The defined modulator describes the modulation (BPSK, QPSK, 8PSK, etc.); the constellation mapping; the number of repetitions (4, 6, etc.); the type of modulation (differential, coherent); the frequency domain pre-emphasis; OFDM generation (IFFT, with cyclic prefix); and windowing.

Structure of the physical frames is defined according to the fundamental system parameters, including the number of FFT points and overlapped samples, the size of cyclic prefixes, the number of symbols in the preamble, and the sampling frequency. The physical layer supports two types of frames: the data frame and the ACK/NACK frame. Each frame starts with a preamble used for synchronization and detection, as well as automatic gain control (AGC) adaptation. The preamble is followed by data symbols allocated to the frame control header (FCH) with the number of symbols depending on the number of carriers used by the OFDM modulation.

The FCH is a data structure transmitted at the beginning of each data frame. It contains information regarding modulation and the length of the current frame in symbols. The FCH also includes a frame control checksum (CRC, or cyclic redundancy check), which is used for error detection. The size of the CRC depends on the frequency band being utilized.

The PHY layer includes an adaptive tone mapping (ATM) feature to optimize maximum robustness. The added ATM feature is implemented first by estimating the SNR of the received signal subcarriers (tones), and then adaptively selecting the usable tones and the optimum modulation and coding type to ensure reliable communication over the powerline channel. Tone mapping also specifies the power level for the remote transmitter and the gain values to be applied for the various sections of the spectrum. The per-carrier quality measurement enables the system to adaptively avoid transmitting data on subcarriers with poor quality. Using a tone map indexing system, the receiver understands which tones are used by the transmitter to send data and which tones are filled with dummy data to be ignored. The goal of the ATM is to achieve the greatest possible throughput under the given channel conditions between the transmitter and the receiver.

A transmission protocol between the MAC and the PHY layer includes different data primitives accessible between the MAC and PHY layers. Several primitives may be provided. A PD-DATA.request primitive is generated by a local MAC sublayer entity and issued to its PHY entity to request the transmission of a PHY service data unit (PSDU). A PD-DATA.confirm primitive confirms the end of the transmission of a PSDU from the local PHY entity to a peer PHY entity. A PD-DATA.indication primitive indicates the transfer of a PSDU from the PHY to the local MAC sublayer entity. The PHY layer may include a management entity called the PLME (physical layer management entity). The PLME provides layer-management service interfaces functions. It is also responsible for maintaining the PHY information base.

The MAC layer is an interface between the logical link control (LLC) layer and the PHY layer. The MAC layer regulates access to the medium by using CSMA/CA (carrier sense, multiple access with collision avoidance). It provides feedback to upper layers in the form of positive and negative acknowledgements (ACK or NACK) and also performs packet fragmentation and reassembly. Packet encryption/decryption is carried out by the MAC layer as well.

A tone map response MAC command may be provided to utilize adaptive tone mapping. The MAC sublayer generates a tone map response command if the tone map request (TMR) bit of a received packet segment control field is set. This means that a packet originator has requested tone map information from a destination device. The destination device must estimate this particular communication link between two points and report the optimal PHY parameters. The tone map information includes the index associated with PHY parameters: the number of used tones and allocation (tone map), the modulation mode, the TX power control parameters, and the link quality indicator (LQI).

The Physical Layer (PHY) may operate in the frequency range of less than 500 kHz and provide up to 500 kbps PHY channel rate. An IEEE 1901.2 device may send MAC data frames that are greater in length then 400 bytes, while a G3 device is limited to a maximum of 400 bytes.

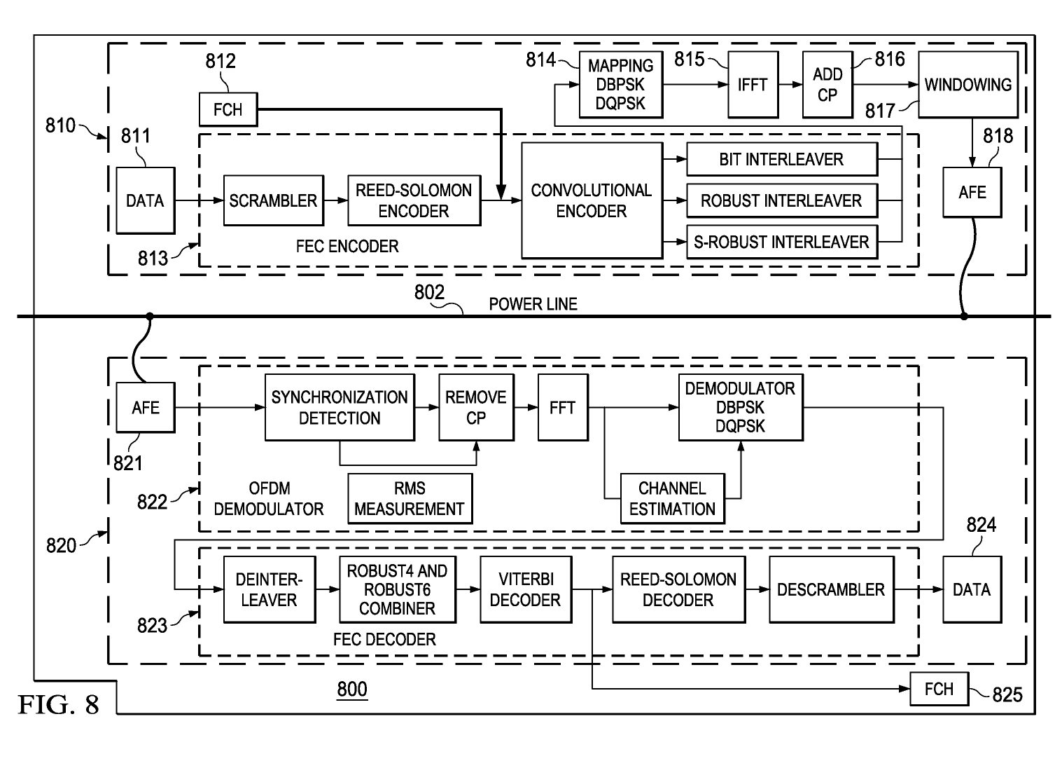

FIG. 7 is a flow chart illustrating a method for padding a frame of data to ensure successful transmission on frequency selective PLC channels. This method may be implemented in either software or hardware or a combination of software and hardware.

Initially, a set L of packet lengths that result in successful transmission of packets over a frequency selective PLC channel is determined 702, as described in more detail above. Set L may be determined by performing physical experiments or by simulation, for example. As discussed above, a particular set L may depend on which frequency band is being used for the PLC communication.

Set L may be determined and then stored in a transmitter device when the device is manufactured, or when it is installed in the field and its software is configured, for example. The set L may be periodically updated in the field, for example.

In some embodiments, a network central coordinator may occasionally or periodically initiate a testing phase to validate set L. In this case, the central coordinator may distribute an updated set L for use in a current network configuration.

During normal network operation, as data packets are received 704 at the MAC layer of a transmitter node, the MAC layer may determine 706 if the payload length of the packet is one of the lengths contained in set L. If not, then the MAC layer may pad 708 the packet to a larger frame length that is contained in set L. As discussed above in more detail, set L may contain several lengths or in some cases it may contain only a single packet length.

Each packet that is padded may be padded 708 with data bytes that have a zero value, or the padding bytes may have non-zero values.

For data packets that are determined 706 to have a length that is in set L, no padding is needed.

Each packet is then forwarded 710 to the PHY layer where it is encoded into OFDM symbols and then transmitted across the frequency selective communication channel.

This method may be applied to all frequency bands using the G3-PLC standard. This method may also be applied to all frequency bands using the IEEE 1901.2, for example.

FIG. 8 is a block diagram of an exemplary low cost, low power G3 and 1901.2 compatible device 800 illustrating an OFDM transmitter 810 and receiver 820 for use in a power line communication node for PLC over a power line 802. As discussed above, the power line channel is very hostile. Channel characteristics and parameters vary with frequency, location, time and the type of equipment connected to it. The lower frequency regions from 10 kHz to 200 kHz used in G3 PLC and in IEEE 1901.2 are especially susceptible to interference. Furthermore, the power line is a very frequency selective channel. Besides background noise, it is subject to impulsive noise often occurring at 50/60 Hz, and narrowband interference and group delays up to several hundred microseconds.

As described in more detail above, OFDM is a modulation technique that can efficiently utilize the limited bandwidth specified by CENELEC and IEEE 1901.2, and thereby allows the use of advanced channel coding techniques. This combination facilitates a very robust communication over a power line channel.

The CENELEC bandwidth is divided into a number of sub-channels, which can be viewed as many independent PSK modulated carriers with different non-interfering (orthogonal) carrier frequencies. Convolutional and Reed-Solomon coding provide redundancy bits allowing the receiver to recover lost bits caused by background and impulsive noise. A time-frequency interleaving scheme may be used to decrease the correlation of received noise at the input of the decoder, providing diversity.

Data 811 and a frame control header 812 are provided by an application via a media access layer (MAC) of the communication protocol. An OFDM signal is generated by performing IFFT (inverse fast Fourier transform) 815 on the complex-valued signal points that are produced by differentially encoded phase modulation from forward error correction encoder 813 using Reed Solomon encoding. Tone mapping 814 is performed to allocate the signal points to individual subcarriers. An OFDM symbol is built by appending a cyclic prefix (CP) 816 to the beginning of each block generated by IFFT 815. The length of a cyclic prefix is chosen so that a channel group delay will not cause successive OFDM Symbols or adjacent sub-carriers to interfere. The OFDM symbols are then windowed 817 and impressed on power line 802 via analog front end 818. AFE 818 provides isolation of transmitter 810 from the 50/60 Hz power line voltage.

Similarly, receiver 820 receives OFDM signals from power line 802 via AFE 821 that isolates receiver 820 from the 50/60 HZ power line voltage. OFDM demodulator 822 removes the CP, converts the OFDM signal to the time domain using FFT (Fast Fourier Transform), and performs demodulation of the phase shift keyed (DBPSK, DQPSK) symbols. FEC decoder 823 performs error correction using Reed Solomon decoding and then descrambles the symbols to produce received data 824. Frame control header 825 information is also produced by FEC decoder 820, as defined by the G3 and IEEE 1901.2 PLC standards.

A blind channel estimation technique may be used for link adaptation. Based on the quality of the received signal, the receiver decides on the modulation scheme to be used, as defined in the PLC standards. Moreover, the system may differentiate the subcarriers with bad SNR (signal to noise ratio) and not transmit data on them.

Transmitter 810 and receiver 820 may be implemented using a digital signal processor (DSP), or another type of microprocessor, that is executing control software instructions stored in memory that is coupled to the microprocessor, for example, to perform FEP encoding, mapping and OFDM modulation, demodulation and FEP decoding. In other embodiments, portions or all of the transmitter or receiver may be implemented with hardwired control logic, for example. The analog front ends 818, 821 require analog logic and isolation transformers that can withstand the voltage levels present on the power line.

A G3 and IEEE 1901.2 PLC system is specified to have the ability to communicate in both low voltage (LV) power lines, typically 100-240 VAC, as well as medium voltage (MV) power lines (up to approximately 12 kV, by crossing LV/MV transformers. This means that the receiver on the LV side must be able to detect the transmitted signal after it has been severely attenuated as a result of going through a MV/LV transformer. As the signal goes through the transformer it is expected to experience overall severe attenuation in its power level as well as frequency-dependent attenuation that attenuates higher frequencies. Both transmitter and receiver have mechanisms to compensate for this attenuation. The transmitter has the capability to adjust its overall signal level as well as shape its power spectrum based on tone map information provided by a target receiver, while the receiver has both an analog and digital AGC (Automatic Gain Control) in order to achieve enough gain to compensate for the overall attenuation.

### Other Embodiments

In the description herein, some terminology is used that is specifically defined in the G3 and IEEE 1901.2 standards and/or is well understood by those of ordinary skill in the art in PLC technology. Definitions of these terms are not provided in the interest of brevity. Further, this terminology is used for convenience of explanation and should not be considered as limiting embodiments of the invention to the G3 and IEEE 1901.2 standards. One of ordinary skill in the art will appreciate that different terminology may be used in other encoding standards without departing from the described functionality.

Embodiments may be operated on various frequency bands by determining a set of packet lengths that provide successful communication for the particular frequency band, such as CENELEC A, CENELEC B, ARIB or FCC band, for example.

While embodiments may perform padding in the MAC layer, other embodiments may perform padding of a data packet as described herein prior to sending the data packet to the MAC layer, for example.

Embodiments of the receivers and transmitters and methods described herein may be provided on any of several types of digital systems: digital signal processors (DSPs), general purpose programmable processors, application specific circuits, or systems on a chip (SoC) such as combinations of a DSP and a reduced instruction set (RISC) processor together with various specialized accelerators. A stored program in an onboard or external (flash EEP) ROM or FRAM may be used to implement aspects of the signal processing.

The techniques described in this disclosure may be implemented in hardware, software, firmware, or any combination thereof. Various combinations of hardware and/or software state machines may be used. If implemented in software, the software may be executed in one or more processors, such as a microprocessor, application specific integrated circuit (ASIC), field programmable gate array (FPGA), software state machines, or digital signal processor (DSP), for example. The software that executes the techniques may be initially stored in a computer-readable medium such as a flash drive, a compact disc (CD), a diskette, a tape, a file, memory, or any other computer readable storage device and loaded at a manufacturing site for execution in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Certain terms are used throughout the description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the discussion and in the claims, the terms “including” and “comprising” are used in an open-ended fashion, and thus should be interpreted to mean “including, but not limited to . . . . ” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A method for transmitting frames of data across a physical media that has a selective frequency response, the method comprising:
receiving a packet of data bytes having a first length by a media access (MAC) layer of a communication protocol from a local application for transmission to a remote receiver;
padding the packet of data bytes to form a padded packet of data bytes having a predetermined frame length, wherein the predetermined frame length is a frame length that is predetermined to provide correct transmission of a frame of data across the physical media that has a selective frequency response;
encoding the padded packet of data bytes by a physical (PHY) layer of the communication protocol to form multiple tone symbols; and
transmitting the multiple tone symbols on the physical media to the remote receiver.

2. The method of claim 1 wherein the physical media is a power line network.

3. The method of claim 1 wherein the multiple tone symbols are Orthogonal Frequency Division Multiplex (OFDM) symbols.

4. The method of claim 1, wherein the predetermined frame length is selected from a set of predetermined frame lengths.

5. The method of claim 4, further comprising periodically updating the set of predetermined frame lengths.

6. The method of claim 1, wherein the PHY layer performs additional padding while forming the multiple tone symbols.

7. The method of claim 1, wherein each packet is padded using zero value bytes.

8. A non-transitory computer-readable medium storing software instructions that, when executed by a processor, cause a method for transmitting frames of data across a physical media that has a selective frequency response to be performed, the method comprising:
receiving a packet of data bytes having a first length by a media access (MAC) layer of a communication protocol from a local application for transmission to a remote receiver;
padding the packet of data bytes to form a padded packet of data bytes having a predetermined frame length, wherein the predetermined frame length is a frame length that is predetermined to provide correct transmission of a frame of data across the physical media that has a selective frequency response;
encoding the padded packet of data bytes by a physical (PHY) layer of the communication protocol to form multiple tone symbols; and
transmitting the multiple tone symbols on the physical media to the remote receiver.

9. The method of claim 8 wherein the physical media is a power line network.

10. The method of claim 8 wherein the multiple tone symbols are Orthogonal Frequency Division Multiplex (OFDM) symbols.

11. The method of claim 8, wherein the predetermined frame length is selected from a set of predetermined frame lengths.

12. The method of claim 11, further comprising periodically updating the set of predetermined frame lengths.

13. The method of claim 8, wherein the PHY layer performs additional padding while forming the multiple tone symbols.

14. The method of claim 8, wherein each packet is padded using zero value bytes.

15. A power line communication (PLC) device comprising:
an application processor; and
a transmitter coupled to the application processor, wherein the transmitter comprises an analog front end configured to couple OFDM symbols to the power line, and a modulator configured to produce the OFDM symbols representative of data;
wherein the PLC device is configured to transmit data frames to a remote receiver via a power line using a communication protocol, such that the transmitter is configured to perform a method, the method comprising:
receiving a packet of data bytes having a first length by a media access (MAC) layer of a communication protocol from the application processor for transmission to the remote receiver;
padding the packet of data bytes to form a padded packet of data bytes having a predetermined frame length, wherein the predetermined frame length is a frame length that is predetermined to provide correct transmission of a frame of data across the physical media that has a selective frequency response;
encoding the padded packet of data bytes by a physical (PHY) layer of the communication protocol to form multiple tone symbols; and
transmitting the multiple tone symbols on the physical media to the remote receiver.

16. The method of claim 15 wherein the multiple tone symbols are Orthogonal Frequency Division Multiplex (OFDM) symbols.

17. The method of claim 15, wherein the predetermined frame length is selected from a set of predetermined frame lengths.

18. The method of claim 17, further comprising periodically updating the set of predetermined frame lengths.

19. The method of claim 15, wherein the PHY layer performs additional padding while forming the multiple tone symbols.

20. The method of claim 15, wherein each packet is padded using zero value bytes.
